(19) United States
(12) Patent Application Publication
(10) Pub. No.: US 2009/0181645 A1
(43) Pub. Date: Jul. 16, 2009

(54) APPARATUS AND METHOD FOR PROJECTING ELECTRONIC MESSAGES

(76) Inventors: Raymond Chan, Hong Kong (CN); Mun Hoong Leong, Hong Kong (CN)

Correspondence Address: EAGLE IP LIMITED, 22/F., KWAI HUNG HOLDINGS CENTRE, 89 KING'S ROAD, NORTH POINT, HK

(21) Appl. No.: 12/190,593

(22) Filed: Aug. 13, 2008

Related U.S. Application Data
(60) Provisional application No. 61/020,407, filed on Jan. 11, 2008.

(51) Int. Cl. H04L 12/58; H04M 1/00

(52) U.S. Cl. 455/412.1; 455/556.1

(57) ABSTRACT

An apparatus for projecting electronic messages onto external objects and method of performing the same are disclosed. The apparatus contains a wireless module, a microprocessor, and a display module. The wireless module receives an incoming electronic message and displays it via the display module. The apparatus further contains a control panel on which a plurality of buttons is allocated. When a user presses one of the buttons, a reply message is replied to the sender of the electronic message.

### CROSS-REFERENCE TO RELATED APPLICATION

This application claims benefit under 35 U.S.C. §119(e) of U.S. Provisional Application having Ser. No. 61/020,407 filed Jan. 11, 2008, which is hereby incorporated by reference herein in its entirety.

### FIELD OF INVENTION

The invention relates to a method and apparatus for optical projecting of a media content onto an external object.

### BACKGROUND

The invention relates to an electronic device for displaying electronic messages. Nowadays, many electronic devices can display not only the time and date information but also weather and environmental information. Some are also equipped with a projection display module so that the information can be projected onto the ceiling or the wall of a room. As people are more and more relying on real-time and global information, an electronic device without the ability to receive information from the outside sources does not match with people's increasing demand.

Currently, it is very popular for people to use mobile phones to send and read short messages using Short Message Service (SMS), which is capable of transmitting text only, and Multimedia Message Service (MMS), which can also accommodate audio, image, and video transmissions. Hence, there is a need for an electronic device to use existing cellular mobile telephone infrastructure to receive information from outside sources and present it to the user.

### SUMMARY OF INVENTION

In light of the foregoing background, one embodiment of the present invention provides an apparatus for receiving information from the outside sources and projecting them on an external object.

Accordingly, the present invention, in one aspect, is an apparatus for projecting electronic messages, which includes a wireless module, a microprocessor module, and a display module. The wireless module includes a receiving module for receiving projected service messages from a public cellular mobile network. The microprocessor module is coupled to the wireless module, the microprocessor module configured to translate the projected service message into human readable message. The display module is coupled to the microprocessor. The display module is adapted to project the human readable message on an external object.

In an another aspect of the invention, a method for projecting electronic messages on an apparatus which includes a wireless module, a microprocessor module and a display module, includes the steps of receiving a projected service message at the wireless module from a public cellular mobile network, translating the projected service message into human readable message, and projecting the human readable message on an external object by the display module.

In a further aspect of the invention, a system for delivering and projecting projected service messages includes a plurality of desk-top projecting devices and at least one central server which is configured to send electronic messages to the desk-top projecting devices via said public cellular mobile network. each desk-top projecting device includes a wireless module which receives a projected service message from a public cellular mobile network, a microprocessor coupled to the wireless module; the microprocessor translates the projected service message into human readable message, and a display module coupled to the microprocessor, which projects the human readable message on an external object.

In this embodiment, the projecting apparatus interacts with huge number of cellular network subscribers to provide a novel function to the users of the apparatus. When an external user sends an electronic message to the phone number that is assigned to the projecting apparatus, the projecting apparatus receives the electronic message via the cellular network, and then displays the content of the message, for example, projects it on the wall. This is a fast and convenient way of displaying an electronic message.

Besides, quick reply function is also provided in the projecting apparatus such that the user selects a frequently used reply message to the incoming message, without the need to manually input it on an input device. This is especially useful for people who have difficulties in inputting text on a keypad and also it saves a lot of time of inputting.

### BRIEF DESCRIPTION OF FIGURES

FIG. 1 is the block diagram of the message projector and its interaction with the cellular mobile phone according to one embodiment.

FIG. 2 shows the message flow between the cellular mobile phone and the message projector according to one embodiment.

FIG. 3 shows text message flow between the cellular mobile phones and the message projectors according to another embodiment.

FIG. 4 and FIG. 5 show multimedia message flow between the cellular mobile phones and the message projectors the message projector according to a further embodiment.

FIG. 6 is the block diagram of the message projector with a keyboard according to another embodiment.

### DETAIL DESCRIPTION OF THE PREFERRED EMBODIMENT

As used herein and in the claims, “desk-top” means the object is usually placed on top of a desk or table but also it can be placed on other flat and horizontal surfaces.

In a first embodiment of the current invention, the message projector includes a wireless transceiver in the wireless module, a microcontroller in the microprosessor module, and one or more display means in the display module. The wireless transceiver is connected to the microcontroller. The display means are connected to the microcontroller to display the contents that received from the wireless transceiver.

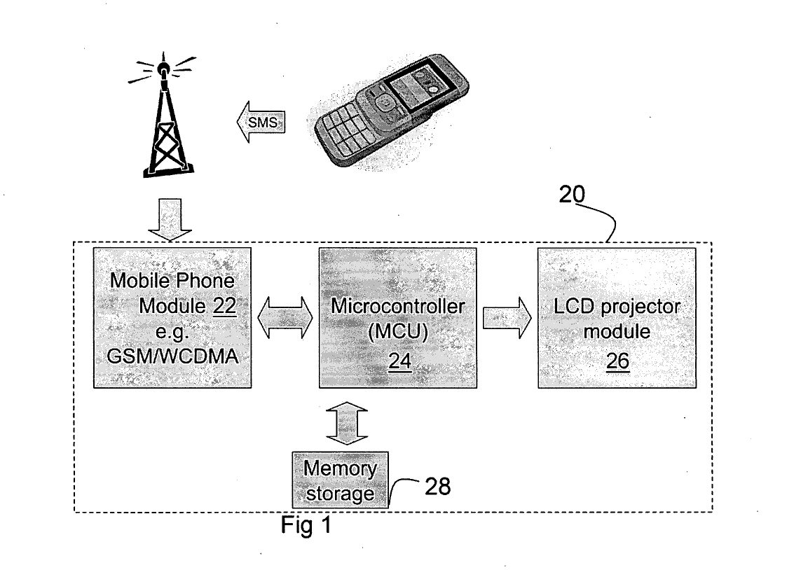

In one exemplary embodiment as shown in FIG. 1, the wireless transceiver 22 contains a communication function similar to a mobile phone, for example, Global System for Mobile Communication (GSM), Personal Communications Services (PCS) or Wideband Code Division Multiple Access (WCDMA) module, which is capable of accessing the cellular network and communicating with other devices in the network. In this embodiment, the transceiver 22 is an internal component which is installed inside the message projector. The transceiver 22 further includes one or more smart card module that can hold a Subscriber Identity Module (SIM) card. The display means 26 is preferably a LCD projector that can project the content of the message to a screen or a wall. There is also a memory storage device 28 for storing the received messages. The memory storage device can be either internal Read Only Memory (ROM) or an external storage drive, such as a Secure Digital (SD) card. All of the above modules are connected to the microcontroller 24.

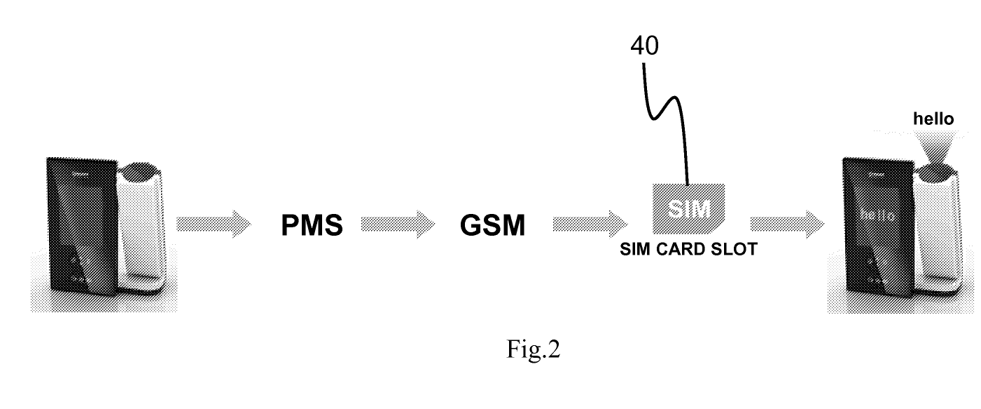

Turning to FIG. 2 now, a SIM card 40 issued by a mobile operator is first installed at the smart-card reader module of the message projector 20. The SIM card is assigned a unique mobile phone number. In operation, an external mobile phone sends a message (here referred as the Projected Service Message) via the GSM cellular network to the mobile phone number specified by the SIM card. After the mobile phone module receives the message, the message projector then displays the content of the message in one or more display devices which will be further described in the following paragraphs.

In another exemplary embodiment, the message projector further includes a phone dock, which is a docking station that can receive a mobile phone. The wireless module is a mobile phone which may be similar to any mobile phone available on the market. There is no other internal wireless module built inside the message projector. Within the phone dock there is a dock connector which is able to be connected to a data port of the mobile phone. Through this connection, the messages or any other contents stored in the mobile phone, such as audio, video or image files, or even user settings like clock, alarm, calendar, to-do list, address book, appointment, etc are read by the message projector. The message projector then projects messages, audio, video or image files onto an external object. The user settings at the message project, such as alarm or clock settings can be synchronized so that they will be the same as that on the user's mobile phone. Optionally, the dock may have the charging module of the phone and necessary electrical wiring for connection to any electrical outlet such that the mobile phone battery can be charged up. i.e. the dock may also work as the phone charger.

There can be one or more display means installed on the message projector. For example, a small Liquid Crystal Display (LCD) and/or Light Emitting Diode LCD/LED screen can be installed on the message projector to show the content of the message and other control information of the message projector to the user when he is operating the device. Another display mean is a LCD projector that project light onto the ceiling or wall so that a plurality of people view the content at the same time. Preferably, the LCD projector and the LCD/LED screen are able to display high-resolution images and videos with high color depth, so as to display the image or video that is embedded in a Multimedia Message Services (MMS) message.

The message projector is optionally equipped with a function that alerts the user when a new message has arrived. There are many ways to notify the user, for example, by using a buzzer to play an alert sound or using a flash light. As described above, such alerts may be downloaded from a mobile phone if it is docked on the message projector.

Besides the messages received from other devices in the cellular network, the message projector optionally displays other kinds of information. This can be local information such as the current time and date from its internal clock. In addition, the message projector may contain one or more environmental sensors such as a thermometer or a hygrometer, where such environmental information can also be presented to the user.

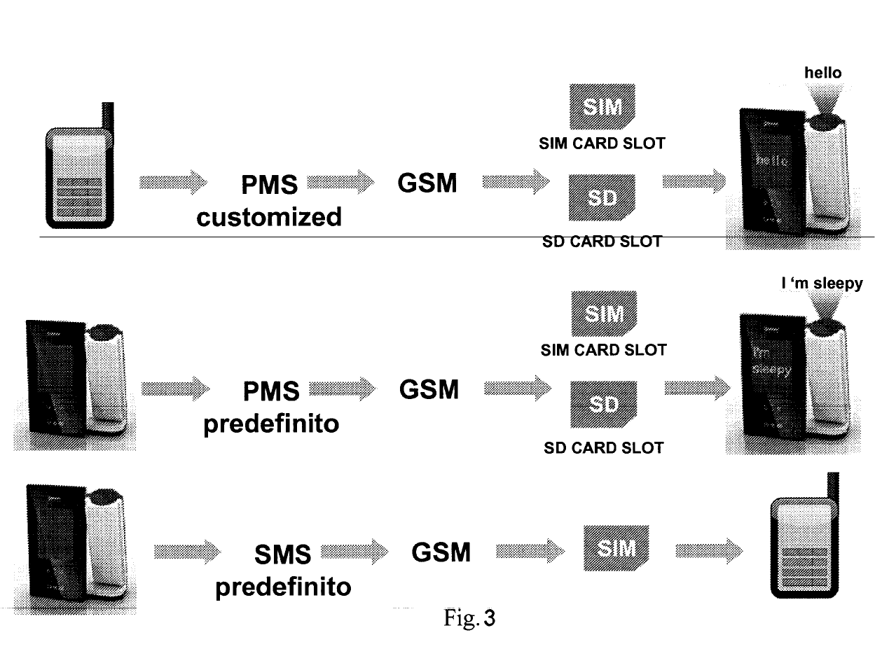

In another exemplary embodiment, the message projector also has a feature of replying to the sender's message. As illustrated in FIG. 3, when a message projector received a message from an external mobile phone, the user of the message projector choose to reply to the mobile phone using one of several predefined messages. For example, when the external mobile phone sends a message saying “Hello!” to the message projector, the user of the message projector can reply to it with the message “I am sleepy”, which will be transmitted by the mobile phone module to the cellular network and reach the external mobile phone at the other end. Alternatively, the reply message can be sent to another message projector as the message is being forwarded. Consequently, the second message projector may directly respond to the external mobile phone user as well as send a reply message to the first message projector user. In one embodiment, the reply message is sent via the user's mobile phone which is docked on the message projector. The reply message itself is stored in the message projector, but the mobile phone is used as a wireless module to send the reply message to the external mobile phone.

The predefined messages are usually very short messages that are frequently used in short message communications. For example, these messages can be “I am fine, thanks”, “No I am not free at this moment”, “see you again”, “LOL”, etc. The predefined messages are stored in the memory device in the message projector. When a user wishes to reply to an external mobile phone user using one of these messages, he can directly choose the appropriate one from a list rather than manually typing the content. This is very useful to elderly people and children, as it may be difficult and uncomfortable for them to type characters on an input device like a keyboard.

In one exemplary embodiment, the message projector provides the user with a control panel as an input means to enable the user to select the reply message directly through the panel. The control panel can be configured in various ways for the user to choose the appropriate reply message. In one configuration, there is a plurality of buttons placed on the control panel, where the user selects an appropriate message by pressing the corresponding button. In another configuration, there is a dropdown list shown on the screen where the user scrolls up or down the list and select the appropriate message on the list.

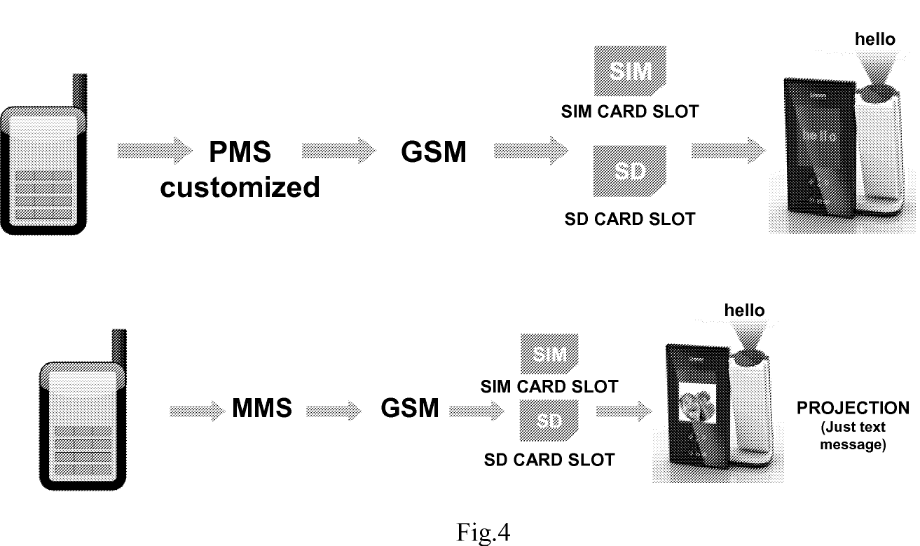

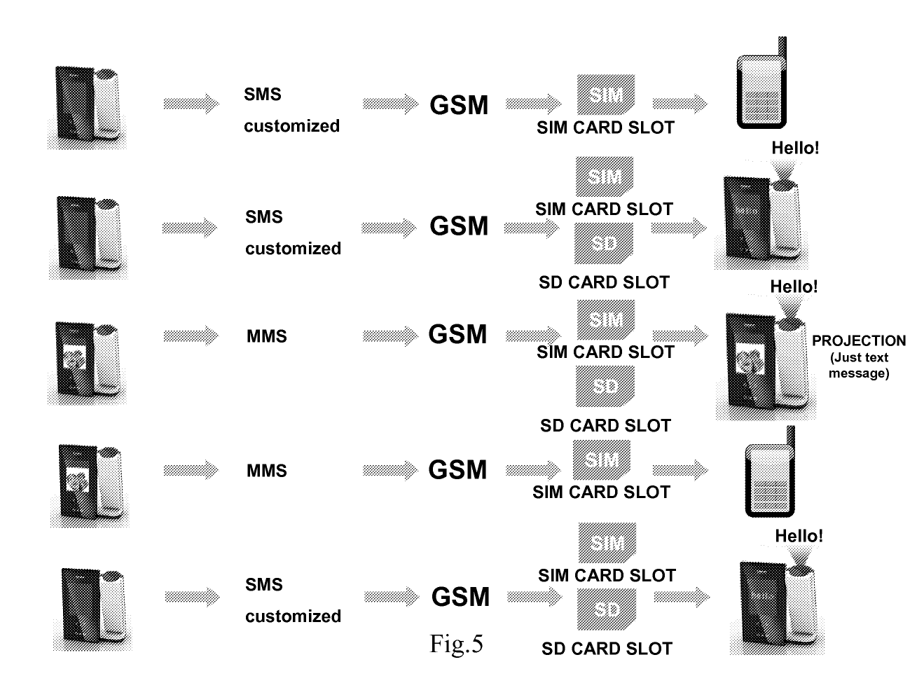

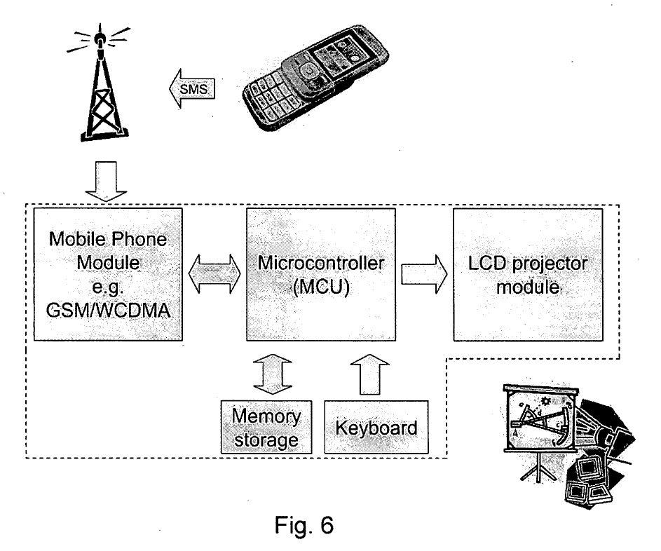

As illustrated in FIG. 4 and FIG. 5, both the sent message and replied message can be in the form of MMS messages as well. The message projector is then equipped with necessary devices and/or software programs to display the embedded audio, video or images in the MMS messages. Likewise, the message projector may contain an additional microphone or camera to capture the voice or image of the user before the message projector and embed them into the reply MMS message. In another configuration, the message projector may contain a data transfer port capable of connecting with and transferring audio, video or image files between the projector and an external memory storage device or a computer. In yet another configuration, the message projector may, in addition or in substitution, contain a wireless communications receiver or transmitter module (such as an infrared, radio frequency, “Bluetooth” or “Wi-Fi” module) capable of wirelessly receiving and transmitting such audio, video or image files between the projector and any other device equipped with similar wireless communications modules. In yet another configuration, the audio, video or images files are obtained from the mobile phone which is docked on the message projector.

In another exemplary embodiment, the message projector is capable of initiating the sending of certain message contents to one or more specific phone numbers. For example, when there is an emergency event occurred, the message projector is able to send a pre-defined message to the emergency number to ask for help. Instead of manually typing the content, the pre-defined messages are sent out much faster. This rapid response time is critical to reporting an incident quickly, whether it is a fire, accident, or medical emergency. More preferably, the message projector realizes automatic incidents discovery and reporting. In one configuration, the message projector contains a smoke detector, which detects the unusual increase of smoke concentration in the air when there is a fire incident in the room. Then the message projector sends out a pre-defined message including the current time, the location of the house, and the contact number of the householder to the fire and rescue department. During the process, no user operation is required. In another configuration, the message projector may be equipped with a wireless heart rate monitor, which the user is wearing on his chest. When the heart rate monitor detects that the heart rate of the user is in an abnormal range, then it sends the sensor information to the message projector wirelessly. The message projector then sends a message containing the personal information of the patient and his syndrome to a specified doctor's clinic to call for immediate assistance.

In another embodiment as shown in FIG. 4, the message projector is further equipped with a keyboard or keypad such that the user is able to manually input the content of the reply message as well as the mobile phone numbers that he wishes to send the message to. The keyboard is installed on the message project as an integrated design, or it could be an external device like a wireless keyboard, which is communicating with the message projector using Radio Frequency (RF), infrared, Bluetooth, or any other communication technologies. In one embodiment, the user uses the keyboard of the mobile phone which is docked on the message projector to input the content of the reply message.

In one embodiment, there is a phone list stored in the message projector, which is similar to the counterpart used on mobile phones. With the phone list, the user of the message projector chooses which recipient(s) he wishes to send messages to and there is no need to manually input the telephone number every time.

In one embodiment, the message projector recognizes certain commonly used text messages sent from a mobile phone user. When the message projector receives the message, it recognizes the text and automatically selects a corresponding reply message and sends them out. In another embodiment, this function also achieves the effect of auto-reply, as when the user is out of home or office, the message projector replies to the external mobile phone user notifying that the person he is looking for is out and please leave a message, etc.

In one embodiment, the message projector receives special predefined codes contained in a message that is sent to it, which is then used for programming or command-and-control functions. In one embodiment, the user uses a mobile phone to monitor, control, or retrieve information from the device remotely. This function enables a huge number of possible applications for the message projector. As an example, when a user is at work and is informed that he needs to get up early next morning from home, he immediately sends a message with a special predefined code that contains the specific alarm time to the message projector. He needs not wait until he goes home to set the message projector's alarm clock. As another example, when a mobile phone user is not at home and wishes to retrieve any new messages received by the message projector, he sends a message with another special predefined command code to the message projector, which in turn transmits a copy of such messages to the mobile phone or inform the mobile phone user that there are no new messages. In addition, to protect the privacy of the user of the message projector, a password or pass code is used so such that no messages will be sent to the mobile phone user unless the password or pass code is correctly entered. Further, if the password or pass code is entered incorrectly after a prescribed number of attempts, this function is locked or disabled, thus preventing the message projector from performing this function until the user resets the message projector.

In one embodiment, there are one or more message service providers, which offer short messages subscription plans to message projector users. The users subscribes to one or more plans to receive regularly updated information which includes but not limited to news, finance information, stock information, weather information, sports-related news, new service promotion, etc. The message service provider then sends the updated messages to the message projectors through the cellular network to push the information to them.

In one embodiment, the message projector further includes other kinds of communication devices beside the mobile phone module. For example, the message projector includes a network adapter or a modem so that it accesses the Internet to receive the messages as well as other kinds of information such as real-time news or weather. In one configuration, there is a central server in the Internet that provides service to one or more message projector users. Each message projector has a unique ID for identifying them in the network. The central server is equipped with a cellular network transceiver so that a user can dial in a unified number (e.g. 1234) to connect to the server, and send SMS/MMS message to the message projector. The message should contain the ID of the message projector(s) that the user wants to send the message to, and the server will only forward the message to that particular message projector(s). The message projector is also be equipped with buttons so that a message projector user at home can also send pre-defined and stored messages to the external mobile phone user via the service provided by the central server.

For a residence that has more than one message projector devices, it may be expensive for each of them to subscribe for a unique SIM card from the mobile operator. An alternative is to have the ‘Main-Cordless’ system that comprises a plurality of message projector devices adopting a second communication means, while one of them equipped with a mobile phone module. In operation, when the device with the mobile phone module receives a message, it broadcasts to other nearby devices using the second communication means. This second communication mean is a low-cost RF transceiver operating at 433 MHz frequency or maybe other wireless technologies such as Bluetooth, Wi-Fi or Zigbee, . . . , etc. Alternatively, it may also be an apparatus using power-line communication technology. Also, the message projector may communicate with other types of devices using the short communications means to forward received messages to these devices. For example, if one message projector received a message from a remote user, the message is then forwarded to nearby devices such as other message projectors or mobile phones by using Bluetooth. This saves the cost of forwarding the message via the cellular network, as Bluetooth communication will not incur any cost.

In another embodiment, the message projector is equipped with a speaker/microphone module to enable voice communication over the cellular network. In this way, the message projector functions similar to a mobile phone but it realizes much more functions than the latter. For example, when someone is making a call to the message projector, the message projector instantaneously projects the caller's information such as his telephone number or his photo, if any, to the wall.

The embodiments of the present invention are thus fully described. Although the description referred to particular embodiments, it will be clear to one skilled in the art that above embodiments can be practiced with variation of these specific details. Hence this invention should not be construed as limited to the embodiments set forth herein.

The small screen installed on the message projector described previously is LED screen or LCD screen, and the projector is of the type of LCD projector. However, it is obvious to one skilled in the art that other kinds of display technologies can be used for display the messages. For example, Vacuum fluorescent display, Plasma, Cathode Ray Tubes (CRT) Projector, Digital Light Processing (DLP) Projector, LED Projector, Laser TV, etc.

What is claimed is:

1. A apparatus for projecting electronic messages comprising:
a) a wireless module, said wireless module comprising a receiving module for receiving projected service messages from a public cellular mobile network;
b) a microprocessor module coupled to said wireless module; said microprocessor module configured to translate said projected service message into human readable message; and
c) a display module coupled to said microprocessor; said display module adapted to project said human readable message on an external object.

2. The apparatus of claim 1, wherein said wireless module is capable of transmitting said electronic messages via said public cellular mobile network.

3. The apparatus of claim 2, wherein said apparatus is configured to be able to automatically send a reply message to said sender without the intervention of said user.

4. The apparatus of claim 2, wherein said apparatus further comprising a control panel on which at least one switch is provided; said switch coupled to said microprocessor module to generate a reply message to the sender of said projected service message upon activation.

5. The apparatus of claim 2, wherein said wireless module is an external device which is detachable from said microprocessor module.

6. The apparatus of claim 1, wherein said projected service message further comprises specific code; said microprocessor interpreting said specific code and performing specific function according to said specific code.

7. The apparatus of claim 1 further comprises at least one sensor that measures local environmental information; wherein said apparatus is capable of projecting said local environmental information on said external object.

8. The apparatus of claim 1 further comprises short-range communication module such that said projected service messages are forwarded to other portable apparatus by said short-range communication module.

9. The apparatus of claim 1, wherein said wireless module is a mobile phone; said apparatus further comprising a phone dock for receiving said mobile phone therein; said phone dock further connecting said mobile phone to said apparatus through a dock connector wherein said apparatus is configured to read stored messages from said mobile phone and displays them on said external object.

10. The apparatus of claim 9, wherein said apparatus is further configured to read user settings from said mobile phone and to synchronize the settings of said apparatus to said user settings.

11. The apparatus of claim 10, wherein said user settings comprises alarm setting or clock setting.

12. A method for projecting electronic messages on an apparatus, said apparatus comprising a wireless module, a microprocessor module and a display module; said method comprising the steps of:
a) receiving a projected service message at said wireless module from a public cellular mobile network;
b) translating said projected service message into human readable message; and
c) projecting said human readable message on an external object by said display module.

13. The method of claim 12, wherein said wireless module is capable of transmitting said electronic messages via said public cellular mobile network.

14. The method of claim 13, wherein said apparatus automatically sends a reply message to said sender without the intervention of said user.

15. The method of claim 13, wherein said apparatus further comprises a control panel on which at least one switch is provided; said switch coupled to said microprocessor module to generate a reply message to the sender of said projected service message.

16. The method of claim 12, wherein said wireless module is an external device which is detachable from said apparatus.

17. The method of claim 16, wherein said wireless module is a mobile phone; said apparatus further comprising a phone dock for receiving said mobile phone therein; said phone dock further connecting said mobile phone to said apparatus through a dock connector wherein said apparatus reads stored messages from said mobile phone and displays them on said external object.

18. The method of claim 12, wherein said projected service message further comprises specific code; said microprocessor module interpreting said specific code and performing specific function according to said specific code.

19. The method of claim 12, wherein said apparatus further comprises at least one sensor that measures local environmental information; wherein said apparatus is capable of projecting said local environmental information on said external object.

20. The method of claim 12, wherein said apparatus further comprises short-range communication module such that said projected service messages are forwarded to other apparatus by said short-range communication module.

21. A System for delivering and projecting projected service messages comprising:
a) a plurality of desk-top projecting devices; each said device comprising:
i) a wireless module, said wireless module receiving a projected service message from a public cellular mobile network;
ii) a microprocessor coupled to said wireless module; said microprocessor translating said projected service message into human readable message;
iii) a display module coupled to said microprocessor; said display module projecting said human readable message on an external object; and
b) at least one central server, said central server configured to send electronic messages to said desk-top projecting devices via said public cellular mobile network.

22. The system of claim 21, wherein said projected service message wherein said electronic messages comprising:
a) financial information;
b) stock market indices;
c) currency exchange rates;
d) weather information;
e) sports-related news;
f) headline news, and
g) any combination thereof.

23. The system of claim 21, wherein said central server is capable of receiving external messages from external users; said external messages comprising an identification code of one particular said desk-top projecting device such that said central server only forwarding said external message to said one particular desk-top projecting device.
